(19) United States
(12) Patent Application Publication
(10) Pub. No.: US 2021/0158227 A1
(43) Pub. Date: May 27, 2021

(54) SYSTEMS AND METHODS FOR GENERATING MODEL OUTPUT EXPLANATION INFORMATION

(71) Applicant: ZestFinance, Inc., Burbank, CA (US)

(72) Inventors: Jerome Louis Budzik, Burbank, CA (US); Sean Javad Kamkar, Burbank, CA (US)

(21) Appl. No.: 17/104,776

(22) Filed: Nov. 25, 2020

Related U.S. Application Data
(60) Provisional application No. 62/940,120, filed on Nov. 25, 2019.

(51) Int. Cl. G06N 20/20; G06N 5/04; G06N 5/00

(52) U.S. Cl. CPC G06N 20/20; G06N 5/003; G06N 5/04

(57) ABSTRACT

Systems and methods for explaining models.

### CROSS-REFERENCE TO RELATED APPLICATIONS

This application claims priority to U.S. Provisional Application No. 62/940,120, filed 25 Nov. 2019, which is incorporated herein in its entirety by this reference.

### TECHNICAL FIELD

This invention relates to the data modeling field, and more specifically to a new and useful system for understanding models.

### BACKGROUND

It is often difficult to understand a cause for a result generated by a machine learning system.

There is a need in the data modeling field to create new and useful systems and methods for understanding reasons for an output generated by a model. The embodiments of the present application provide such new and useful systems and methods.

### BRIEF DESCRIPTION OF THE FIGURES

FIG. 1A illustrates schematics of a system, in accordance with embodiments.

FIG. 1B illustrates schematics of a system, in accordance with embodiments.

FIGS. 2A-C illustrate a method, in accordance with embodiments.

FIG. 3 illustrates schematics of a system, in accordance with embodiments.

FIGS. 4A-D illustrate a method for determining feature groups, in accordance with embodiments.

FIG. 5 illustrates exemplary output explanation information, in accordance with embodiments.

FIG. 6 illustrates exemplary output-specific explanation information generated for a model output, in accordance with embodiments.

FIG. 7 illustrates generation of output-specific explanation information generated for a model output, in accordance with embodiments.

FIGS. 8A-E illustrate exemplary models, in accordance with embodiments.

### DESCRIPTION OF THE PREFERRED EMBODIMENTS

The following description of preferred embodiments of the present application are not intended to be limiting, but to enable any person skilled in the art of to make and use these embodiments described herein.

### 1. Overview

It is useful to understand how a model makes a specific decision or how a model computes a specific score. Such explanations are useful so that model developers can ensure each model-based decision is reasonable. These explanations have many practical uses, and for some purposes they are particularly useful in explaining to a consumer how a model-based decision was made. In some jurisdictions, and for some automated decisioning processes, these explanations are mandated by law. For example, in the United States, under the Fair Credit Reporting Act 15 U.S.C. § 1681 et seq, when generating a decision to deny a consumer credit application, lenders are required to provide to each consumer the reasons why the credit application was denied. These reasons should be provided in terms of factors the model actually used, and should also be in terms that enable a consumer to take practical steps to improve their credit application. These adverse action reasons and notices are easily provided when the model used to make a credit decision is a simple, linear model. However, more complex, ensembled machine learning models have proven difficult to explain.

The disclosure herein provides such new and useful systems and methods for explaining each decision a machine learning model makes, and it enables businesses to provide natural language explanations for model-based decisions, so that businesses may use machine learning models, provide a better consumer experience and so that businesses may comply with the required consumer reporting regulations.

Embodiments herein provide generation of output explanation information for explaining output generated by machine learning models. Such explanation information can be used to provide a consumer with reasons why their credit application was denied by a system that makes lending decisions based on a machine learning model.

In some variations, the system includes a model evaluation system that functions to generate output explanation information that can be used to generate output-specific explanations for model output. In some variations, the system includes a machine learning platform (e.g., a cloud-based Software as a Service (SaaS) platform).

In some variations, the method includes at least one of: determining influence of features in a model; generating output explanation information based on influence of features; and providing generated output explanation information.

In some variations, any suitable type of process for determining influence of features in a model can be used (e.g., generating permutations of input values and observing score changes, computing gradients, computing Shapley values, computing SHAP values, determining contribution values at model discontinuities, etc.).

In some variations, to generate output explanation information, feature groups of similar features are identified. In some implementations, similar features are features having similar feature contribution values (that indicate influence of a feature in a model). In some implementations, similar features are features having similar distributions of feature contribution values across a set of model outputs.

In some variations, generating output explanation information includes assigning a human-readable explanatory text to each feature group. In some implementations, each text provides a human understandable explanation for a model output impacted by at least one feature in the feature group. In this manner, features that have similar impact on scores generated by the model can be identified, and an explanation can be generated that accounts for all of these related features. Moreover, explanations can be generated for each group of features, rather than for each individual feature.

In some variations, the method includes generating output-specific explanation information (for output generated by the model) by using the identified feature groups and corresponding explanatory text. In some variations, explaining an output generated by the model includes identifying a feature group related to the output, and using the explanatory text for the identified feature group to explain the output generated by the model.

In some variations, identifying feature groups includes: identifying a set of features used by the model; for each pair of features included in the identified set of features, determining a similarity metric that quantifies a similarity between the features in the pair; and identifying the feature groups based on the determined similarity metrics. In some embodiments, a graph is constructed based on the identified features and the determined similarity metrics, with each node representing a feature and each edge representing a similarity between features corresponding to the connected nodes; a node clustering process is performed to cluster nodes of the graph based on similarity metric values assigned to the graph edges, wherein clusters identified by the clustering process represent the feature groups (e.g., the features corresponding to the nodes of each cluster are the features of the feature group).

### 2. System

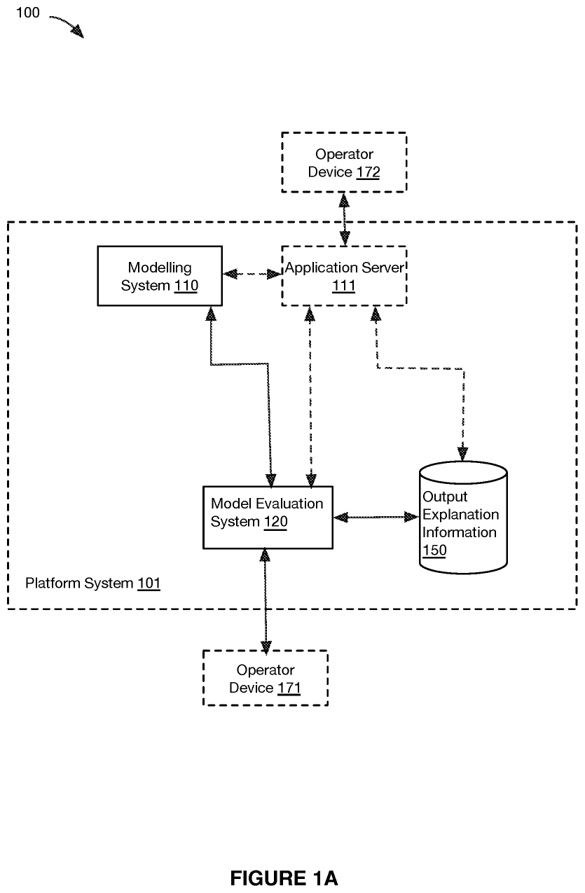

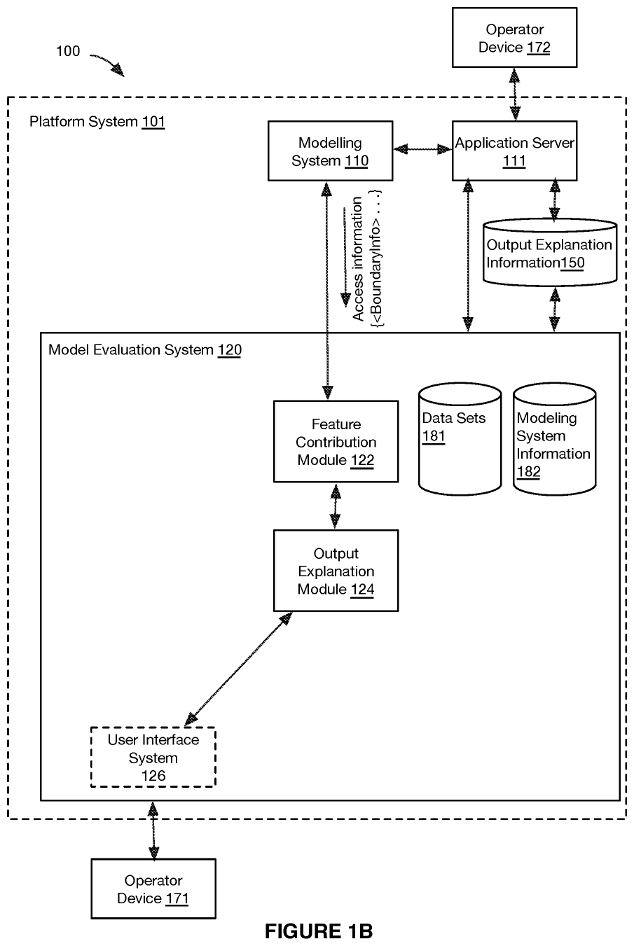

In variants, the system 100 includes at least a model evaluation system 120 that functions to generate output explanation information. The system can optionally include one or more of: an application server (e.g., 111), a modeling system (e.g., 110), a storage device that functions to store output explanation information (e.g., 150), and one or more operator devices (e.g., 171, 172). In variants, the system includes a platform system 101 that includes one or more components of the system (e.g., 110, 111, 120, 150, as shown in FIG. 1A). In some variations, the system includes at least one of: a feature contribution module (e.g., 122) and an output explanation module (e.g., 124), as shown in FIG. 1B.

In some variations, the machine learning platform is an on-premises system. In some variations, the machine learning platform is a cloud-system. In some variations, the machine learning platform functions to provide software as a service (SaaS). In some variations, the platform 101 is a multi-tenant platform. In some variations, the platform 101 is a single-tenant platform.

In some implementations, the system 100 includes a machine learning platform system 101 and an operator device (e.g., 171). In some implementations, the machine learning platform system 101 includes one or more of: a modeling system 110, a model evaluation system 120, and an application server 111.

In some implementations, the application server 111 provides an on-line lending application that is accessible by operator devices (e.g., 172) via a public network (e.g., the internet). In some implementations, the lending application functions to receive credit applications from an operator device, generate a lending decision (e.g., approve or deny a loan) by using a predictive model included in the modeling system 110, provide information identifying the lending decision to the operator device, and optionally provide output-specific explanation information to the operator device if the credit application is denied (e.g., information identifying at least one FCRA Adverse Action Reason Code).

In some implementations, the model evaluation system (e.g., 120) includes at least one of: the feature contribution module 122, the output explanation module 124, a user interface system 128, and at least one storage device (e.g., 181, 182).

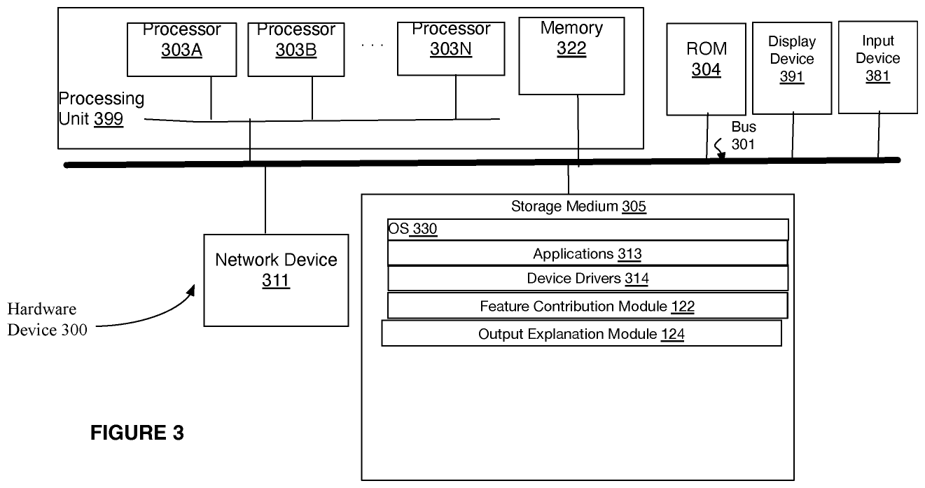

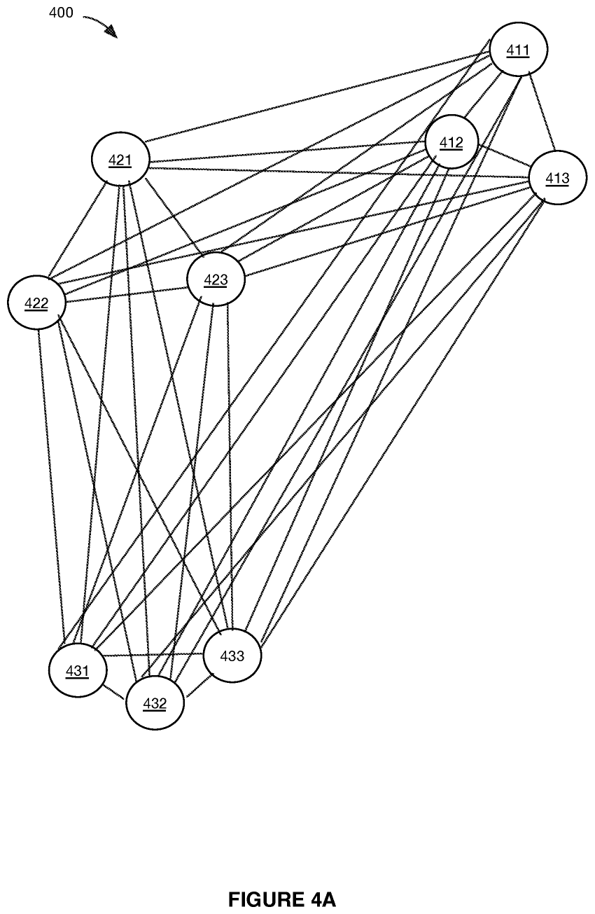

In some implementations, at least one component (e.g., 122, 124, 128) of the model evaluation system 120 is implemented as program instructions that are stored by the model evaluation system 120 (e.g., in storage medium 305 or memory 322 shown in FIG. 3) and executed by a processor (e.g., 303A-N shown in FIG. 3) of the system 120.

In some implementations, the model evaluation system 120 is communicatively coupled to at least one modeling system 110 via a network (e.g., a public network, a private network). In some implementations, the model evaluation system 120 is communicatively coupled to at least one operator device (e.g., 171) via a network (e.g., a public network, a private network).

In some variations, the user interface system 128 provides a graphical user interface (e.g., a web interface). In some variations, the user interface system 128 provides a programmatic interface (e.g., an application programming interface (API)).

In some variations, the feature contribution module 122 functions to determine influence of features in a model. In some variations, the feature contribution module 122 functions to determine feature contribution values for each feature, for at least one output (e.g., a score) generated by a model (e.g., a model included in the modeling system 110).

In some implementations, the feature contribution module 122 functions to determine feature contribution values by performing a method described in U.S. Patent Application Publication No. US-2019-0279111 (“SYSTEMS AND METHODS FOR PROVIDING MACHINE LEARNING MODEL EVALUATION BY USING DECOMPOSITION”), filed 8 Mar. 2019, the contents of which is incorporated herein.

In some implementations, the feature contribution module 122 functions to determine feature contribution values by performing a method described in U.S. Patent Application Publication No. US-2020-0265336 (“SYSTEMS AND METHODS FOR DECOMPOSITION OF DIFFERENTIABLE AND NON-DIFFERENTIABLE MODELS”), filed 19 Nov. 2019, the contents of which is incorporated by reference.

In some implementations, the feature contribution module 122 functions to determine feature contribution values by performing a method described in U.S. Patent Application Publication No. US-2018-0322406 (“SYSTEMS AND METHODS FOR PROVIDING MACHINE LEARNING MODEL EXPLAINABILITY INFORMATION”), filed 3 May 2018, the contents of which is incorporated by reference.

In some implementations, the feature contribution module 122 functions to determine feature contribution values by performing a method described in U.S. Patent Application Publication No. US-2019-0378210 (“SYSTEMS AND METHODS FOR DECOMPOSITION OF NON-DIFFERENTIABLE AND DIFFERENTIABLE MODELS”), filed 7 Jun. 2019, the contents of which is incorporated by reference.

In some implementations, the feature contribution module 122 functions to determine feature contribution values by performing a method described in “GENERALIZED INTEGRATED GRADIENTS: A PRACTICAL METHOD FOR EXPLAINING DIVERSE ENSEMBLES”, by John Merrill, et al., 4 Sep. 2019, arxiv.org, the contents of which is incorporated herein.

In some variations, the output explanation module 124 functions to generate output explanation information based on influence of features determined by the feature contribution module 122.

In some variations, the output explanation module 124 generates output-specific explanation information for output generated by a model being executed by the modeling system 110. In some variations, the output-specific explanation information for an output includes at least one FCRA Adverse Action Reason Code.

### 3. Method

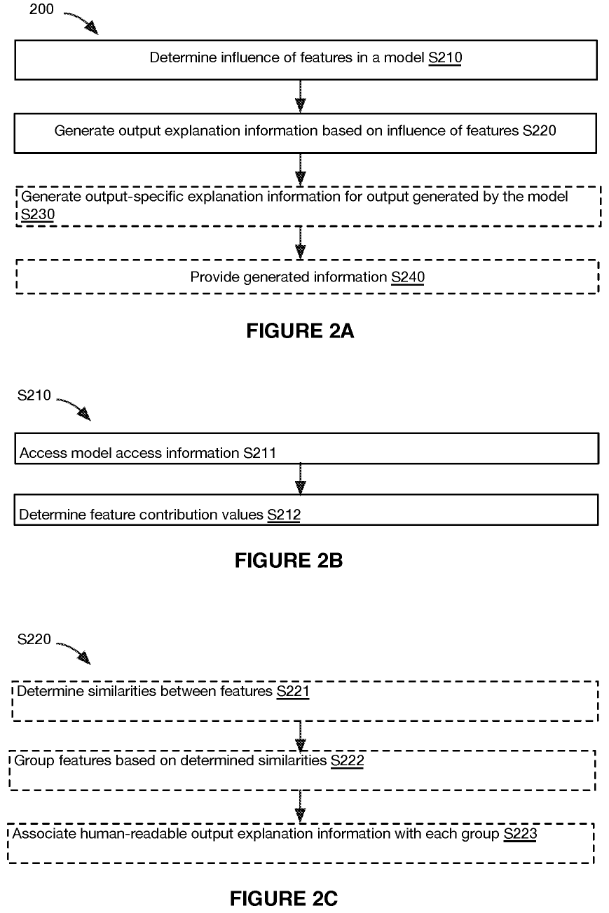

As shown in FIG. 2A, a method 200 includes at least one of: determining influence of features in a model (S210); and generating output explanation information based on influence of features (S220). The method can optionally include one or more of generating output-specific explanation information for output generated by the model (S230); and providing generated information (S240). In some variations, at least one component of the system (e.g., 100 performs at least a portion of the method 200.

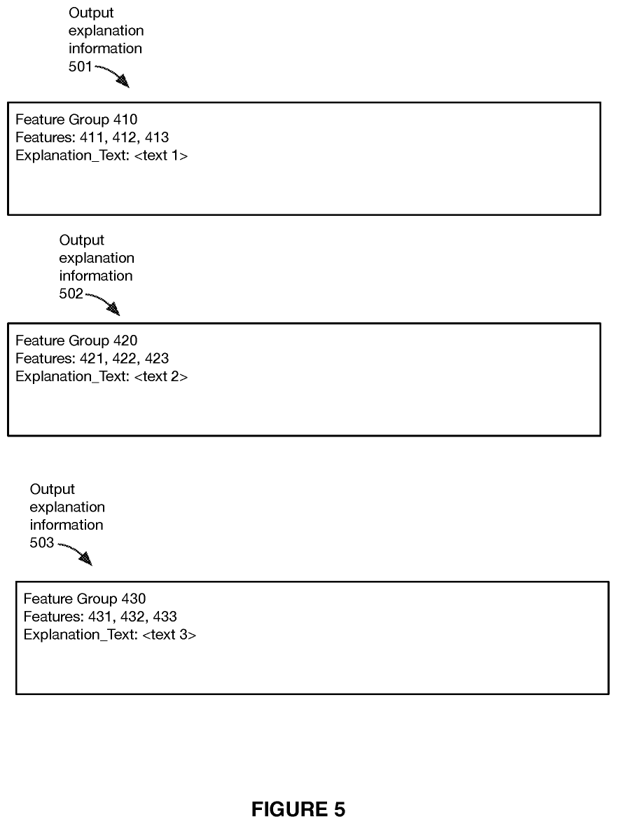

The method 200 can be performed in response to any suitable trigger (e.g., a command to generate explanation information, detection of an event, etc.). In variants, the method 200 is performed (e.g., automatically) in response to re-training of the model used by the modeling system no (e.g., to update the output explanation information for the model). For example, the method 200 can function to automatically generate output explanation information (e.g., as shown in FIG. 5) each time a model is trained (or re-trained), such that the generate output explanation information is readily available for generation of output-specific explanation information for output generated by the models. By virtue of the foregoing, operators do not need to manually map features to textual explanations each time a model is trained or re-trained.

In some variations, the model evaluation system 120 performs at least a portion of the method 200. In some variations, the feature contribution module 122 performs at least a portion of the method 200. In some variations, the output explanation module 124 performs at least a portion of the method 200. In some variations, the user interface system 126 performs at least a portion of the method 200.

In some implementations, a cloud-based system performs at least a portion of the method 200. In some implementations, a local device performs at least a portion of the method 200.

In some variations, S210 functions to determine influence of features in a model (e.g., a model included in the modelling system no) by using the feature contribution module 122.

The model can be any suitable type of model, and it can be generated by performing any suitable machine learning process including one or more of: supervised learning (e.g., using logistic regression, back propagation neural networks, random forests, decision trees, etc.), unsupervised learning (e.g., using an Apriori algorithm, k-means clustering, etc.), semi-supervised learning, reinforcement learning (e.g., using a Q-learning algorithm, temporal difference learning, etc.), and any other suitable learning style. In some implementations, the model can implement any one or more of: a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminant analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolutional network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and any suitable form of machine learning algorithm. In some implementations, the model can additionally or alternatively leverage: a probabilistic module, heuristic module, deterministic module, or any other suitable module leveraging any other suitable computation method, machine learning method or combination thereof. However, any suitable machine learning approach can otherwise be incorporated in the model.

The model can be a differentiable model, a non-differentiable model, or an ensemble of differentiable and non-differentiable models. For such ensembles, any suitable ensembling function can be used to ensemble outputs of sub-models to produce a model output (percentile score).

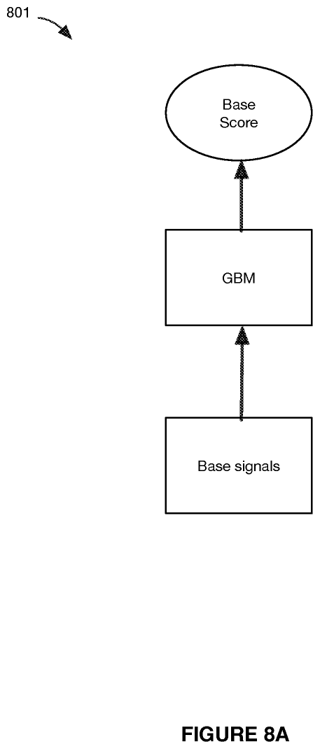

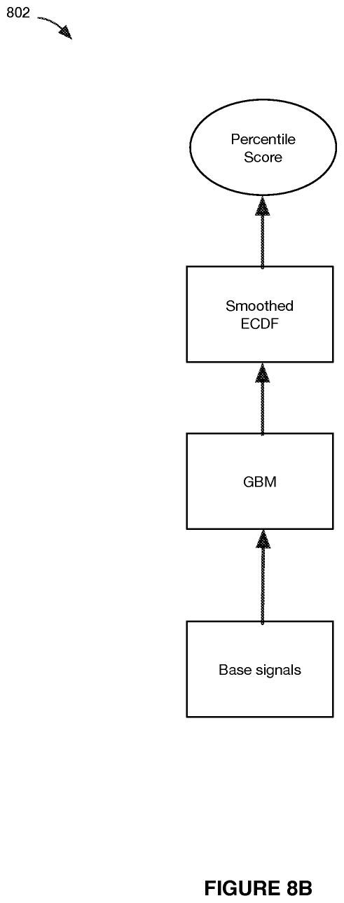

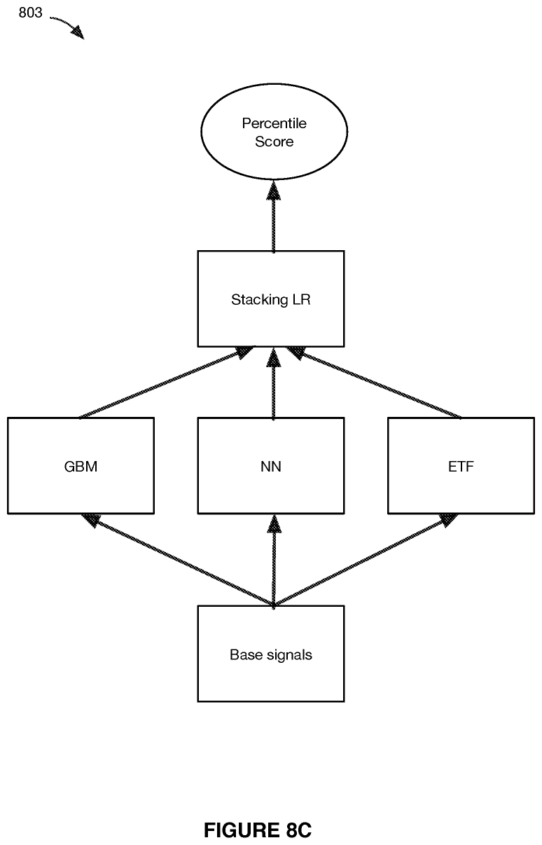

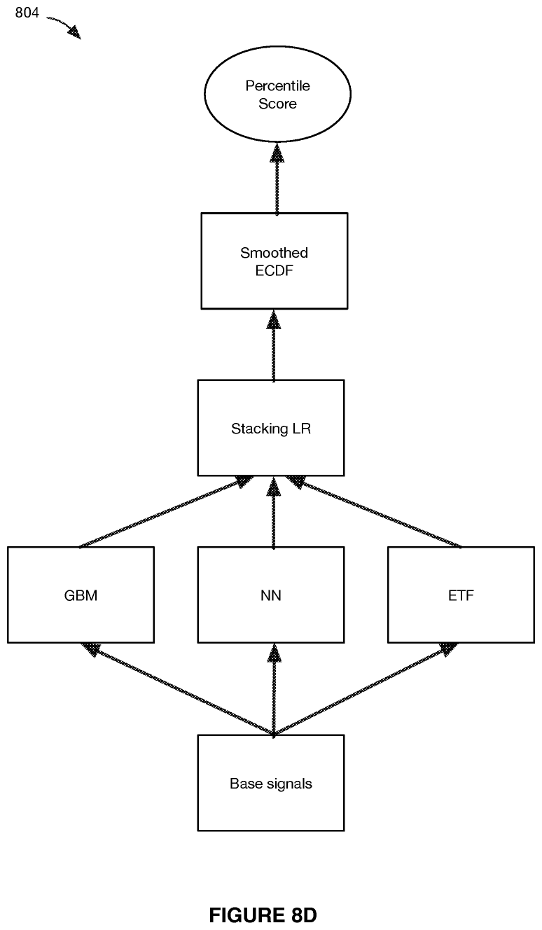

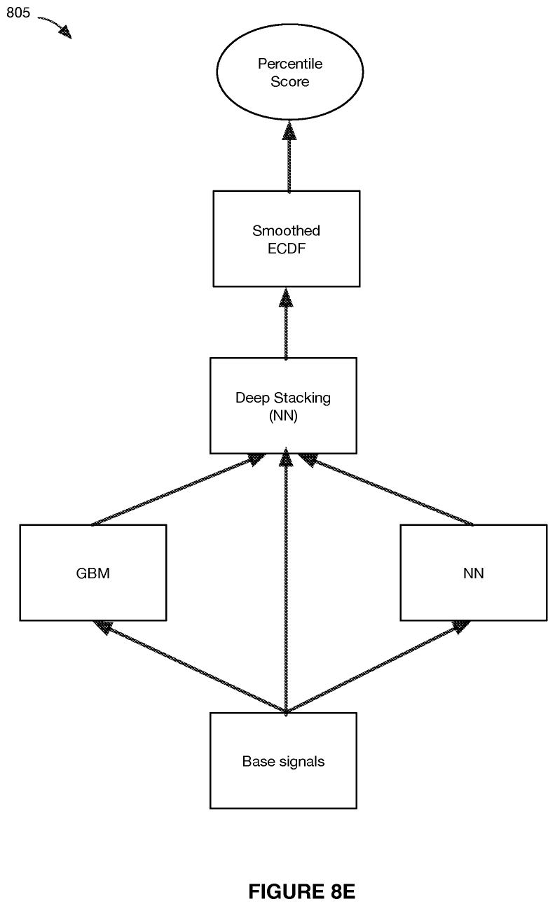

FIGS. 8A-E show schematic representations of exemplary models 801-805. In a first example, the model 801 includes a gradient boosted tree forest model (GBM) that outputs base scores by processing base input signals.

In a second example, the model 802 includes a gradient boosted tree forest model that generates output base scores by processing base input signals. The output of the GMB is processed by a smoothed Empirical Cumulative Distribution Function (ECDF), and the output of the smoothed ECDF is provided as the model output (percentile score).

In a third example, the model 803 includes sub-models (e.g., a gradient boosted tree forest model, a neural network, and an extremely random forest model) that each generate outputs from base input signals. The outputs of each sub-model are ensembled by using a linear stacking function to produce a model output (percentile score).

In a fourth example, the model 804 includes sub-models (e.g., a gradient boosted tree forest model, a neural network, and an extremely random forest model) that each generate outputs from base input signals. The outputs of each sub-model are ensembled by using a linear stacking function. The output of the linear stacking function is processed buy a smoothed ECDF, and the output of the smoothed ECDF is provided as the model output (percentile score).

In a fifth example, the model 805 includes sub-models (e.g., a gradient boosted tree forest model, and a neural network) that each generate outputs from base input signals. The outputs of each sub-model (and the base signals themselves) are ensembled by using a deep stacking neural network. The output of the deep stacking neural network is processed buy a smoothed ECDF, and the output of the smoothed ECDF is provided as the model output (percentile score).

However, the model can be any suitable type of model, and can include any suitable sub-models arranged in any suitable configuration, with any suitable ensembling and other processing functions.

Determining influence of features in the model by using the feature contribution module 122 (S210) can include accessing model access information (S211 shown in FIG. 2B). The model access information (accessed at S211) is used by the feature contribution module 122 to determine influence of features in the model. The model access information can be accessed from a storage device (e.g., 181, 182), an operator device (e.g., 171), or the modeling system (e.g., 110).

In some implementations, the model access information includes at least one of (or includes information used to access at least one of): input data sets; output values; gradients; gradient operator access information; tree structure information; discontinuities of the model; decision boundary points for a tree model; values for decision boundary points of a tree model; features associated with boundary point values; an ensemble function of the model; a gradient operator of the model; gradient values of the model; information for accessing gradient values of the model; transformations applied to model scores that enable model-based outputs; and information for accessing model scores and model-based outputs based on inputs.

In some implementations, accessing model access information (S211) includes invoking a gradient function of the modeling system 110 (e.g., “tensorflow.gradients(<model>, <inputs>)”,) that outputs the model access information. However, a model access information can be accessed in any suitable manner.

In some implementations, accessing model access information (S211) includes invoking a function of the modeling system 110 (e.g., “LinearRegression.get_params( )”,) that outputs the model access information. However, a model access information can be accessed in any suitable manner.

In an implementations, accessing model access information (S211) includes accessing a tree structure of a tree model. Accessing the tree structure can include obtaining a textual representation of the tree model, and parsing the textual representation of the tree model to obtain the tree structure. In some implementations, accessing model access information includes identifying decision boundary points for a tree model (or tree ensemble) by parsing a textual representation of the tree model. In an example, a textual representation of a tree model is obtained by invoking a model export function of the modeling system no (e.g., XGBClassifier.get_booster( )dump_model('XGBModel.txt”, with_stats=TRUE)). However, a textual representation of a tree model can be accessed in any suitable manner.

Determining influence of features in the model by using the feature contribution module 122 (S210) can include determining feature contribution values (S212 shown in FIG. 2B). In some variations, any suitable type of process for determining influence of features in a model can be used (e.g., generating permutations of input values and observing score changes, computing gradients, computing Shapley values, computing SHAP values, determining contribution values at model discontinuities, etc.). In some implementations, the feature contribution module 122 determines feature contribution values by using model access information for the model (accessed at S211).

In variants, determining feature contribution values at S212 includes performing a credit assignment process that assigns a feature contribution value to the features of inputs used by the model to generate a result. The features of inputs used by the model may include various predictors, including: numeric variables, binary variables, categorical variables, ratios, rates, values, times, amounts, quantities, matrices, scores, or outputs of other models. The result may be a score, a probability, a binary flag, or other numeric value.

The credit assignment process can include a differential credit assignment process that performs credit assignment for an evaluation input (row) by using one or more reference inputs (rows). In some variants, the credit assignment method is based on Shapley values. In other variants, the credit assignment method is based on Aumann-Shapley values. In some variants, the credit assignment method is based on Tree SHAP, Kernel SHAP, interventional tree SHAP, Integrated Gradients, Generalized Integrated Gradients (e.g., as described in US-2020-0265336, “SYSTEMS AND METHODS FOR DECOMPOSITION OF DIFFERENTIABLE AND NON-DIFFERENTIABLE MODELS”), or a combination thereof.

Evaluation inputs (rows) can be generated inputs, inputs from a population of training data, inputs from a population of validation data, inputs from a population of production data (e.g., actual inputs processed by the machine learning system in a production environment), inputs from a synthetically generated sample of data from a given distribution, etc. In some embodiments, a synthetically generated sample of data from a given distribution is generated based on a generative model. In some embodiments the generative model is a linear model, an empirical measure, a Gaussian Mixture Model, a Hidden Markov Model, a Bayesian model, a Boltzman Machine, a Variational autoencoder, or a Generative Adversarial Network. Reference inputs (rows) can be generated inputs, inputs from a population of training data, inputs from a population of validation data, inputs from a population of production data (e.g., actual inputs processed by the machine learning system in a production environment), inputs from a synthetically generated sample of data from a given distribution, etc. The total population of evaluation inputs and/or reference inputs can increase as new inputs are processed by the machine learning system (e.g., in a production environment). For example, in a credit risk modeling implementation, each newly evaluated credit application is added to the population of inputs that can be used as evaluation inputs, and optionally reference inputs. Thus, as more inputs are processed by the machine learning system, the number of computations performed during evaluation of the machine learning system can increase.

Performing a credit assignment process can include performing computations from one or more inputs (e.g., evaluation inputs, reference inputs, etc.). Performing a credit assignment process can include selecting one or more evaluation inputs and selecting one or more reference inputs. In some variations, the inputs (evaluation inputs, reference inputs) are sampled (e.g., by performing a Monte Carlo sampling process) from at least one dataset that includes a plurality of rows that can be used as inputs (e.g., evaluation inputs, reference inputs, etc.). Sampling can include performing one or more sampling iterations until at least one stopping criteria is satisfied.

Stopping criteria can include any suitable type of stopping criteria (e.g., a number of iterations, a wall-clock runtime limit, an accuracy constraint, an uncertainty constraint, a performance constraint, convergence stopping criteria, etc.). In some variations, the stopping criteria includes an accuracy constraint that specifies a minimum value for a sampling metric that identifies convergence of sample-based explanation information (generated from the sample being evaluated) to ideal explanation information (generated without performing sampling). In other words, stopping criteria can be used to control the system to stop sampling when a sampling metric computed for the current sample indicates that the results generated by using the current sample are likely to have an accuracy above an accuracy threshold related to the accuracy constraint. Accordingly, variants perform the practical and useful function of limiting the number of calculations to those required to determine an answer with sufficient accuracy, certainty, wall-clock run time, or combination thereof. In some implementations, the stopping criteria are specified by an end-user via a user interface. In some implementations, the stopping criteria are specified based on a grid search or analysis of outcomes. In some implementations, the stopping criteria are determined based on a machine learning model.

Convergence stopping criteria can include a value, a confidence interval, an estimate, tolerance, range, rule, etc., that can be compared with a sampling metric computed for a sample (or sampling iteration) of the one or more datasets being sampled to determine whether to stop sampling and invoke an explanation system and generate evaluation results. The sampling metric can be computed by using the inputs sampled in the sampling iteration (and optionally inputs sampled in any preceding iterations). The sampling metric can be any suitable type of metric that can measure asymptotic convergence of sample-based explanation information (generated from the sample being evaluated) to ideal explanation information (generated without performing sampling). In some variations, the sampling metric is a t-statistic (e.g., bound on a statistical t-distribution). However, any suitable sampling metric can be used. In variants, the stopping criteria identifies a confidence metric that can be used to identify accuracy of the assignments of the determined feature contribution values to the features at S212. For example, stopping criteria can identify a confidence metric that identifies the likelihood that a feature contribution value assigned to a feature at S212 accurately represents the impact of the feature on output generated by the model. This confidence metric can be recorded in association with the feature contribution values determined at S212. However, the confidence metrics can otherwise be used to generate explanation information.

In a first variant of determining feature contribution values, the feature contribution module 122 determines a feature contribution value for a feature of an evaluation input row relative to a reference population that includes one or more reference rows.

In a first implementation (of the first variant), determining a feature contribution value for a feature of an evaluation input row relative to a reference population includes: generating a feature contribution value for the feature (of the evaluation input row) relative to each reference row that is included in the reference population. The feature contribution values generated for each reference row are combined to produce a feature contribution value for the feature of the evaluation input row, relative to the reference population.

In a second implementation (of the first variant), determining a feature contribution value for a feature of an evaluation input row relative to a reference population includes: generating a reference row that represents the reference population. A feature contribution value is generated for the feature (of the evaluation input row) relative to the generated reference row. The feature contribution value generated for the feature (of the evaluation input row) for the generated reference row is the feature contribution value for the feature of the evaluation input row, relative to the reference population.

In variants, generating a feature contribution value for a feature (of the evaluation input row) relative to a reference row (e.g., a row included in a reference population, a row generated from rows included in the reference population, etc.) includes computing the integral of the gradient of the model along the path from the evaluation input row to the reference row (integration path). The computed integral is used to compute the feature contribution value.

For example, a feature contribution value can be generated for each feature of an evaluation input row X, (which includes features {x₁, x₂, x₃}). The feature contribution value for a feature can be computed by using a population of reference rows Ref₁, Ref₂, Ref₃. A feature contribution value is generated for feature x, by using each of reference rows Ref₁, Ref₂, Ref₃. A first contribution value is generated by computing the integral of the gradient of the model along the path from a reference input Ref, to the evaluation input X₁. A second contribution value is generated by computing the integral of the gradient of the model along the path from a reference input Ref₂ to the evaluation input X₁. Finally, a third contribution value is generated by computing the integral of the gradient of the model along the path from a reference input Ref₃ to the evaluation input X₁. The first, second and third contribution values are then combined to produce a feature contribution value for feature x₁ of row X₁ relative to the reference population (e.g., {Ref₁, Ref₂, Ref₃}).

Alternatively, a reference row is generated that represents the reference population {Ref₁, Ref₂, Ref₃}. The reference row can be generated in any suitable manner, e.g., by performing any suitable statistical computation. In an example, for each feature, the feature values of the reference rows are averaged, and the average value for each feature is included in the generated reference row as the reference row's feature value. A feature contribution value is generated for feature x, by using the generated of reference row. A first contribution value is generated by computing the integral of the gradient of the model along the path from the generated reference row to the evaluation input X₁. The first contribution value is the feature contribution value for feature x, of row X₁ relative to the reference population (e.g., {Ref₁, Ref₂, Ref₃}).

In some implementations, the gradient of the output of the model is computed by using a gradient operator. In some implementations, the gradient operator is accessed by using the model access information (accessed at S211). In a first example, the modelling system executes the gradient operator and returns output of the gradient operator of the model evaluation system 120. In a second example, the model evaluation system includes a copy of the model, and the model evaluation system 120 implements and executes a gradient operator to obtain the gradient of the output of the model. For example, the model evaluation system can execute an instance of TensorFlow, execute the model using the instance of TensorFlow, and execute the TensorFlow gradient operator to obtain the gradient for the model. However, the gradient of the output of the model can be obtained in any suitable manner.

In some implementations, for non-continuous models, model access information (accessed at S211) identifies each boundary point of the model, and the feature contribution module 122 determines feature contribution values by identifying input data sets (boundary points) along a path from the reference input to the evaluation input for which the gradient of the output of the model cannot be determined, and segmenting the path at each boundary point (identified by the model access information accessed at S211). Then, for each segment, contribution values for each feature of the model are determined by computing the componentwise integral of the gradient of the model along the segment. A single contribution value is determined for each boundary point, and each boundary point contribution value is assigned to a single feature. In some variations, for each feature, a contribution value for the path is determined by combining the feature's contribution values for each segment, and any boundary point contribution values assigned to the feature.

In variants, assigning a boundary point contribution value to a single feature includes: assigning the boundary point contribution value to the feature at which the boundary occurs. That is, if the feature x₁ is the unique feature corresponding to the boundary point, then the boundary point contribution value assigned to the feature x₁. In a case where the boundary occurs at more than one feature, then the boundary point contribution value is assigned to all features associated with the boundary in even amounts.

In a second variant of determining feature contribution values, the feature contribution module 122 determines feature contribution values by modifying input values, generating a model output for each modified input value, and determining feature contribution values based on the model output generated for the modified input values. In some variations, the change in output across the generated model output values is identified and attributed to a corresponding change in feature values in the input, and the change is attributed to at least one feature whose value has changed in the input.

However, any suitable process or method for determining feature contribution values can be performed at S212.

In an example, the model is a credit model that is used to determine whether to approve or deny a loan application (e.g., credit card loan, auto loan, mortgage, payday loan, installment loan, etc.). A reference input row that represents a set of approved applicants is selected. In variants, rows representing the set of approved loan applicants (represented by the reference input row) are selected by sampling data sets of approved applicants until a stopping condition is satisfied (as described herein). The reference input row can represent a set of barely acceptable loan applications (e.g., input rows having an acceptable credit model score below a threshold value).

A set of denied loan applications is selected as evaluation input rows. In variants, input rows representing the set of denied loan applications (represented by the evaluation input rows) are selected by sampling data sets of denied applicants until a stopping condition is satisfied (as described herein). For each evaluation input row representing a denied loan application, feature contribution values are generated for the evaluation input row, relative to the reference input row that represents the acceptable loan applications. The distribution of feature contrition values for each feature across the evaluation input rows can be determined. These determined distributions identify the impact of each feature in a credit model score that resulted in denial of a loan application. By examining these distributions, an operator can identify reasons why a loan application was denied.

However, credit models can include several thousand features, including features that represent similar data from different data sources. For example, in the United States, credit data is typically provided by three credit bureaus, and the data provided by each credit bureau can overlap. As an example, each credit bureau can have a different feature name for data representing “number of bankruptcies”. It might not be obvious to an average consumer that several variables with different names represent the same credit factor. Moreover, a combination of several features might contribute to a loan applicant's denial in combination. It might not be obvious to an average consumer how to improve their credit application or correct their credit records if given a list of variables that contributed to denial of their loan application. Therefore, simply providing a consumer with a list of features and corresponding feature contribution values might not satisfy the Fair Credit Reporting Act.

Accordingly, there is a need to provide a user-friendly explanation of reasons why a consumer's loan application was denied, beyond merely providing feature contribution values.

To address this need, output explanation information is generated (at S220) based on influence of features determined at S210. In some variations, influence of features is determined based on the feature contribution values determined at S212. In some variations, a set of features used by the model are identified based on model access information accessed at S211. In some variations, the output explanation module 124 performs at least a portion of S220.

S220 can include at least one of S221, S222, and S223, shown in FIG. 2C.

In some variations, generating output explanation information (S220) includes: determining similarities between features used by the model (S221). In some implementations, the features used by the model are identified by using the model access information accessed at S211. Feature similarities can be determined based on influence of features determined at S210. In some embodiments, a similarity metric for a pair of features is computed based on feature contribution values (or distributions of feature contribution values) determined at S212. In some variations, by computing similarity metrics between each pair of features used by the model, the similar features can be grouped such that a single explanation can be generated for each group of features.

For example, a denial of a credit application might be the result of a combination of features, not a single feature in isolation. Merely providing an explanation for each feature in isolation might not provide a complete, meaningful reason as to why a credit application was denied. By identifying groups of features that likely contribute in conjunction to credit denial, a more meaningful and user-friendly explanation can be identified and assigned to the group. In a case where a metric that measures impact of some or all of the features in a feature group on a credit application's denial exceeds a threshold value, the explanation generated for that feature group can be used to explain the application's denial.

In some variations, determining similarities between features (at S221) includes identifying feature groups of similar features. In some implementations, similar features are features having similar feature contribution values or similar distributions of feature contribution values (that indicate influence of a feature in a model).

In some implementations, similar features are features having similar distributions of feature contribution values across a set of model outputs.

For example, if a model uses features x₁, x₂, and x₃, to generate each of scores Score₁, Score₂, and Score₃, then the system 100 determines feature contribution values cᵢⱼ for feature i and score j, as shown below in Table 1.

TABLE 1

| | x₁ | x₂ | x₃ |
|---|---|---|---|
| Score₁ | c₁₁ | c₂₁ | c₃₁ |
| Score₂ | c₁₂ | c₂₂ | c₃₂ |
| Score₃ | c₁₃ | c₂₃ | c₃₃ |

In some implementations, the system determines a distribution dᵢ of feature contribution values for each feature i across scores j. For example, referring to Table 1, the system can determine a distribution of feature contribution values for feature x₁ based on feature contribution values c₁₁, c₁₂, and c₁₃.

In some variations, determining similarities between features (S221) includes: for each pair of features used by the model, determining a similarity metric that quantifies a similarity between the features in the pair. In some variations, determining similarities between features (S221) includes identifying each feature included in input rows used by the model, identifying each pair of features among the identified features, and determining a similarity metric for each pair.

In a first example, each similarity metric between the distributions of the feature contribution values of the features in the pair is determined by performing a Kolmogorov-Smirnov test.

In a second example, each similarity metric between the distributions of the feature contribution values of the features in the pair is determined by computing at least one Pearson correlation coefficient.

In a third example, each similarity metric is a difference between the feature contribution values of the features in the pair.

In a fourth example, each similarity metric is a difference between the distributions of the feature contribution values of the features in the pair.

In a fifth example, each similarity metric is a distance (e.g., a Euclidian distance) between the distributions of the feature contribution values of the features in the pair.

In a sixth example, each similarity metric is based on the distributions of feature values and the feature contribution values of the features in the pair. In variations, each similarity metric is based on the reconstruction error of at least one autoencoder. In variants an autoencoder is trained based on the input features and optimized to minimize reconstruction error. Modified input data sets are prepared based on the original model development data set with each pair of variables swapped. The similarity metric for a pair of variables is one minus the average reconstruction error of the autoencoder run on a modified input data on the modified dataset (where variables are swapped). Intuitively this allows this variant to determine whether substituting one variable with another changes the multivariate distribution of the variables and by how much (one minus the reconstruction error rate).

In a seventh example, a similarity metric is constructed based on metadata associated with a variable. In variations the metadata includes a collection of data source types, a data type (for example, categorial or numeric), the list of transformations applied to generate the variable from source or intermediate data, metadata associated with the applied transformations, natural language descriptions of variables, or a model purpose.

However, any suitable similarity metric can be used at S221 to determine a similarity between a pair of features.

In this way, the system can group hundreds of thousands of variables into a set of clusters of similar features that can be mapped to reasons and natural language explanations.

In variants, generating output explanation information at S220 includes: grouping features based on the determined similarities (S222). In some variations, feature groups are identified based on the determined similarity metrics.

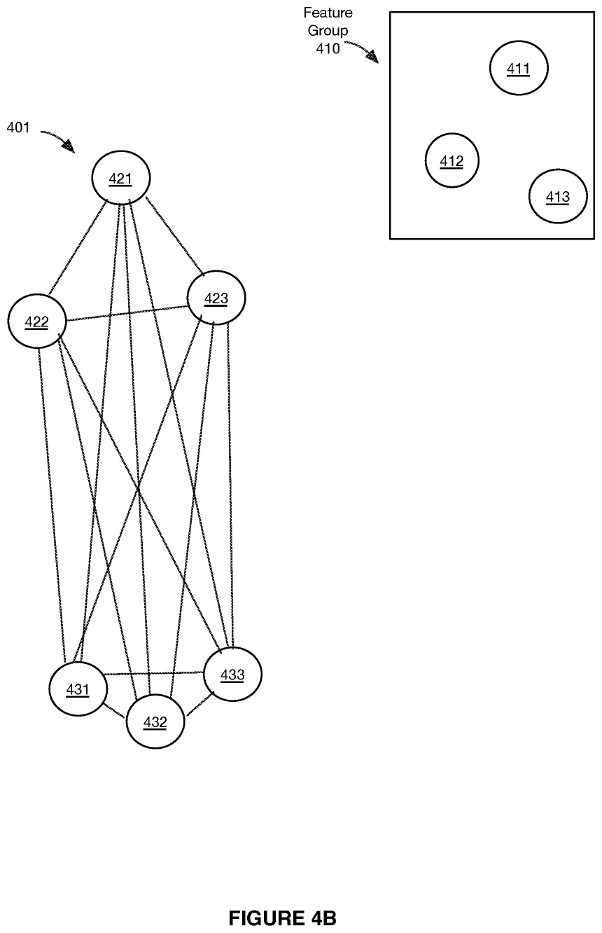

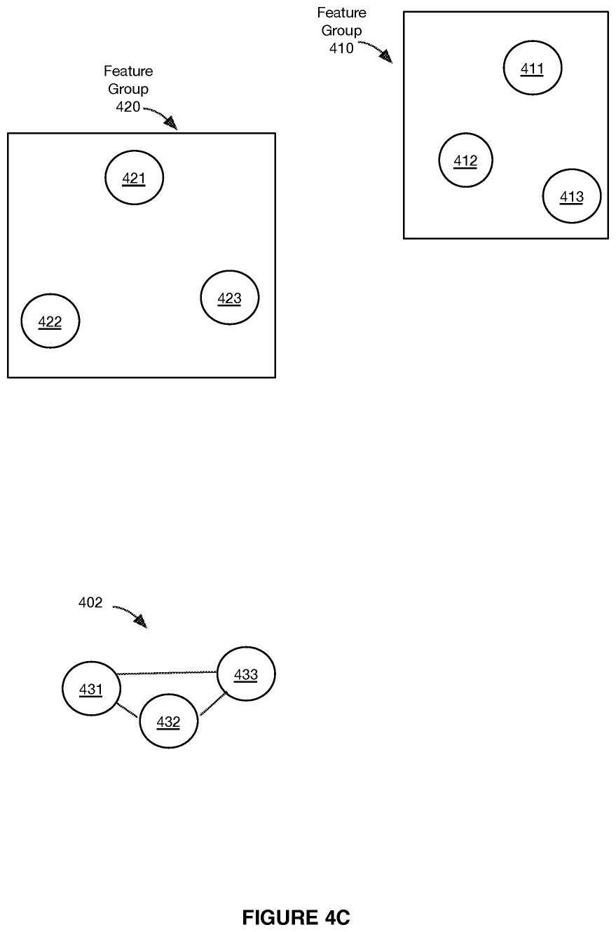

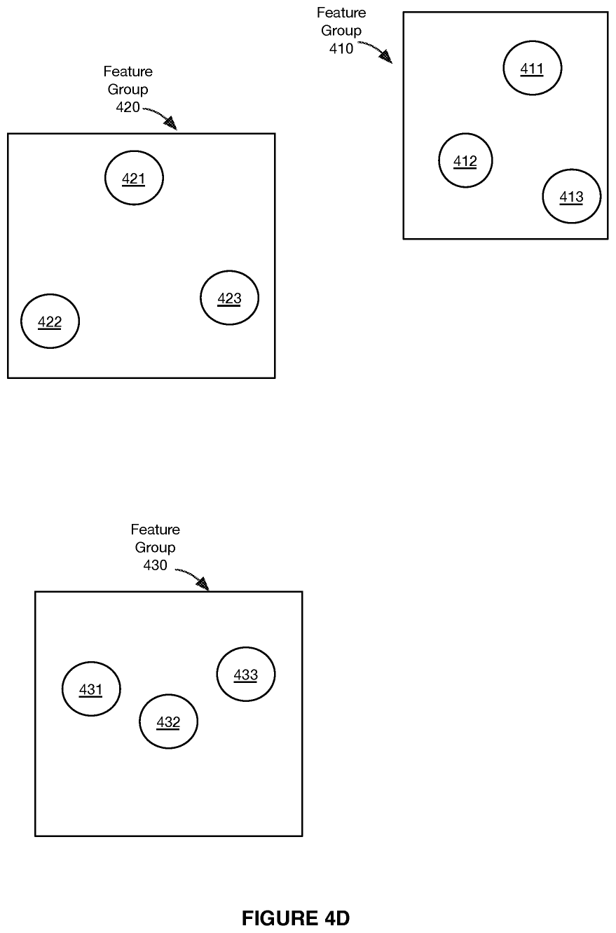

In some embodiments, grouping features (at S222) includes constructing a graph (e.g., 400 shown in FIG. 4A) based on the identified features (e.g., 411, 412, 413, 421, 422, 423, 431, 432, 433 shown in FIG. 4A) and the determined similarity metrics. In some implementations, each node of the graph represents a feature, and each edge between two nodes represents a similarity metric between features corresponding to the connected nodes. Once the graph is constructed, a node clustering process is performed to cluster nodes of the graph based on similarity metrics assigned to the graph edges. Clusters identified by the clustering process represent the feature groups (e.g., 410, 420, 430 shown in FIG. 4D). The features corresponding to the nodes of each cluster are the features of the feature group. In some implementations, the graph is stored (e.g., in the storage medium 305, 150) as a matrix (e.g., an adjacency matrix).

In some implementations, the node clustering process is a hierarchical agglomerative clustering process, wherein the similarity metric assigned to each edge is the metric used by the hierarchical agglomerative clustering process to group the features.

In some implementations, the node clustering process includes identifying a clique in the graph where each edge has a similarity metric above a threshold value.

In some implementations, the node clustering process includes identifying the largest clique in the graph where each edge has a similarity metric above a threshold value.

In some implementations, the node clustering process includes identifying the largest clique in the graph where each edge has a similarity metric above a threshold value; assigning the features corresponding to the nodes of the largest clique to a feature group; removing the nodes corresponding to the largest clique from the graph, and then repeating the process to generate additional feature groups until there are no more nodes left in the graph. FIG. 4B depicts graph 401, which results from identifying feature group 410, and removal of the associated features 411, 412 and 413 from the graph 400. FIG. 4C depicts graph 402, which results from identifying feature group 420, and removal of the associated features 421, 422 and 423 from the graph 401. FIG. 4D depicts removal of all nodes from the graph 402, after identifying feature group 430, and removal of the associated features 431, 432 and 433 from the graph 402.

In some implementations, the largest clique is a maximally connected clique.

However, in variations, any suitable process for grouping features based on similarity metrics can be performed, such that features having similar impact on model outputs are grouped together.

By virtue of constructing the graph as described herein, existing graph node clustering processes can be used to group features. For example, existing techniques for efficient graph node clustering can be used to efficiently group features into feature groups based on the similarity metrics assigned to pairs of features. By representing the graph as a matrix, efficient processing hardware for matrix operations can be used (e.g., GPU's, FPGA's, hardware accelerators, etc.) can be used to group features into feature groups.

In variants, generating output explanation information includes associating human-readable output explanation information (at S223) with each feature group (identified at S222).

In some variations, associating human-readable output explanation information with each feature group (e.g., 410, 420, 430) includes assigning a human-readable explanatory text to at least one feature group. In some implementations, explanatory text is assigned to each feature group. Alternatively, explanatory text is assigned to a subset of the identified feature groups. In some implementations, each text provides a human understandable explanation for a model output impacted by at least one feature in the feature group. In some implementations, information identifying each feature group is stored (e.g., in storage device 150), and the associated explanatory text is stored in association with the respective feature group (e.g., in the storage device 150). In some variations, the human-readable explanatory text is received via the user interface system 126 (e.g., from an operator device 171). In other variations, the human-readable explanatory text is generated based on metadata associated with the variable including its provenance, a data dictionary associated with a data source, and metadata associated with the transformations applied to the input data to generate the final feature. In variants, the features are generated automatically and selected for inclusion in the model based on at least one selection criteria. In some variations, the automatically generated and selected features are grouped based on metadata generated during the feature generation process. This metadata may include information related to the inputs to the feature, and the type of transformation applied.

For example, metadata associated with the variable corresponding to a borrower's debt-to-income ratio (DTI) might include a symbolic representation indicating the source variables for DTI are total debt and total income, both with numeric types. The system then assigns credit to the source variables and creates a group based on these credit assignments.

FIG. 5 depicts exemplary output explanation information 501, 502, and 503 generated at S220. As shown in FIG. 5, each set of output explanation information 501, 502, and 503 includes respective human-readable output explanation information generated at S223 (e.g., “text 1”, “text 2”, “text 3”).

In an example, the feature groups generated at S222 are provided to an operator device (e.g., 171) via the user interface system 126, an operator reviews the feature groups, generates the explanatory text for at least one feature group, and provides the explanatory text to the model evaluation system 120 via the user interface system 126. In this example, the model evaluation system receives the explanatory text from the operator device 171, generates a data structure for each feature group that identifies the features included in the feature group and the explanatory text generated for the feature group, and stores each data structure (e.g., in a storage device 150 shown in FIG. 1A).

In variants, the method includes generating output-specific explanation information for output generated by the model (S230). In some variations, generating output-specific explanation information for output generated by the model includes: using the feature groups (identified at S222) and corresponding explanatory text (associated with at least one identified feature group at S223) to explain an output generated by the model.

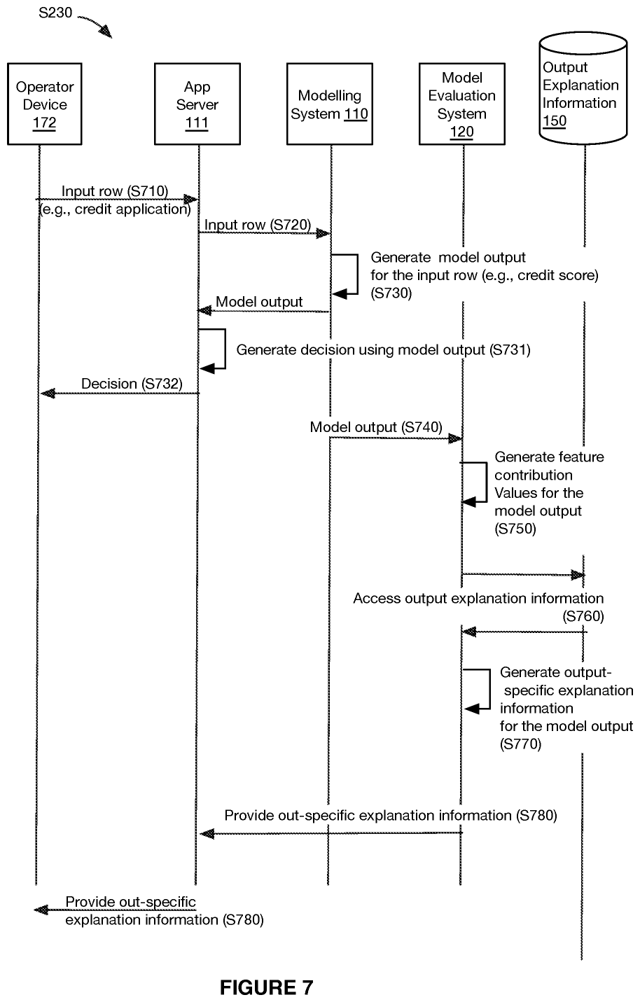

In variants, generating output-specific explanation information for output generated by the model (S230) includes accessing one or more of: an input row used by the model to generate the model output, and the model output. In some implementations, the input row for the model output is accessed from one or more of an operator device (e.g., 171), a modelling system (e.g., 110), a user interface, an API, a network device (e.g., 311), and a storage medium (e.g., 305). In some implementations, the modelling system 110 receives the input row (at S720 shown in FIG. 7) from one of an operator device 172 and an application server 111. In some implementations, the application server 111 provides a lending application that receives input rows representing credit applicants (e.g., from an operator device 172 at S710), and the application server 111 provides received input rows to the modelling system 120 at S720.

The modelling system 110 generates model output for the input row (at S730). In some implementations, the modelling system provides the model output to the application server in, which generates decision information (at S731) by using the model output. In some implementations, the application server provides the decision information to an operator device (e.g., 172) at S732. For example, the operator device 172 can be a borrower's operator device, the input row can be a credit application, and the decision information can be a decision that identifies whether the credit application has been accepted or rejected.

The model output (and corresponding input) can be accessed by the model evaluation system 120 from the modeling system 110 (at S740 shown in FIG. 7) in response to generation of the model output (at S730), so that the model evaluation system can generate explanation information (e.g., adverse action information rejection of a consumer credit application, etc.) for the model output.

For example, the modelling system can generate a credit score (in real time) for a credit applicant, and if the applicant's loan application is rejected, the modelling system can use the model evaluation system 120 to generate an adverse action letter to be sent to the credit application. However, explanation information can be used for any suitable type of application that involves use of output generated by a model.

In some variations, generating output-specific explanation information for an output generated by the model (S230) includes: identifying a feature group related to the output, and using the explanatory text for the identified feature group to explain the output generated by the model.

In some implementations, identifying a feature group related to an output generated by the model includes: generating a feature contribution value for each feature included in an input row used by the model to generate the model output (S750 shown in FIG. 7). In an example, for an input row that includes features x₁, x₂, and x₃, the model evaluation system 120 generates a feature contribution value (c₁₁, c₁₂, and c₁₃) for each feature.

In some implementations, the model evaluation system 120 compares each determined feature contribution value with a respective threshold (e.g., a global threshold for all features, a threshold defined for a specific feature or subset of features, etc.). Features having contribution values above the associated thresholds are identified, information identifying the feature groups are accessed (at S760), and a feature group is identified that includes features having contribution values above the threshold (at S770). For example, if an input row has features x₁, x₂, and x₃, and the contribution values for features x₁, and x₃ are greater than or equal go the respective threshold values (e.g., t₁, and t₃), then the model evaluation system 120 searches (e.g., in the explanation information data store 150) (at S760 shown in FIG. 7) for a feature group that includes features x₁, and x₃. In some implementations, the explanatory text (stored in the explanation information data store 150) associated with the identified feature group is provided as the explanation information for the model output (at S770). In variants, the explanation information for the specific model output is provided to the application server 111 (at S780), which optionally forwards the explanation information to the operator device 172 (at S780).

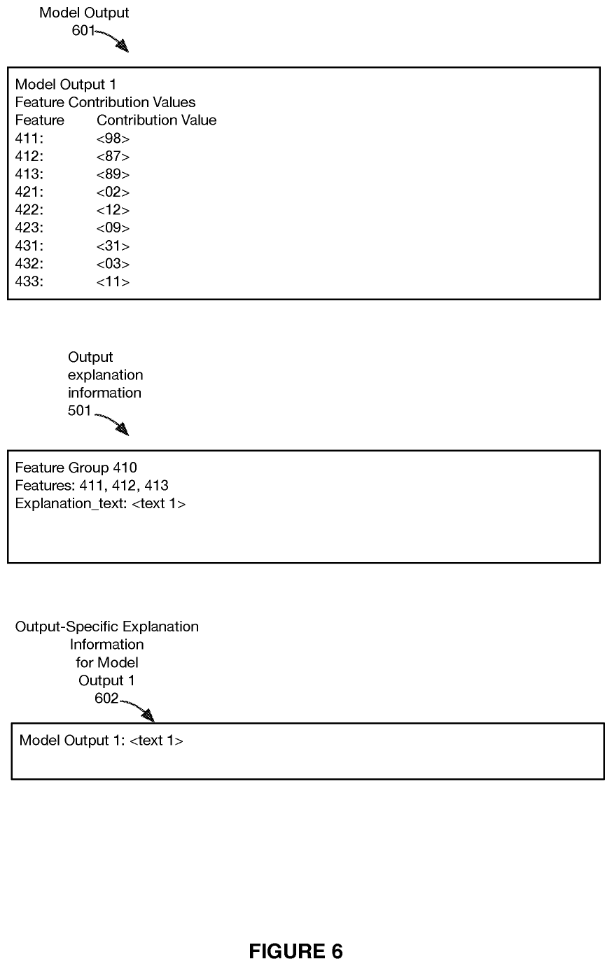

FIG. 6 shows exemplary output-specific explanation information 602 generated at S230. FIG. 6 shows model output information 6oi that identifies a model output, and the feature contribution values for each of features 411, 412, 413, 421, 422, 423, 431, 432, 433. In a case contribution values for features 411, 412, 413 are each above respective thresholds, and the values for the remaining features are not above respective thresholds, output explanation information 501 is selected as the output explanation information for the model output of 601. The explanation text “<text 1>” (associated with 501) is used to generate the output-specific explanation information 602 for the model output related to 601.

In an example, a credit model generates a credit score for a credit applicant (e.g. at S730 shown in FIG. 7), the feature contribution module 122 determines feature contribution values for the credit applicant (e.g., at S750). Feature contribution values for the credit score that are above a threshold value are determined. For example, if both a first feature representing “number of bankruptcies in the last 3 months” and a second feature representing “number of delinquencies in the last 6 months ” each have a feature contribution value for the credit score that are above the threshold value and are highly correlated, then a feature group that includes these two features is identified, and the explanatory text stored in association with this feature group is used to generate an adverse action explanation for the credit applicant's denial of credit. In the above example, the reason might be “past delinquencies”. In this way the method described herein is used to create an initial grouping of variables that a user can label.

In variants, the method 200 includes providing generated information (S240). In some variations, the model evaluation system 120 provides explanation information generated at S220 or S230 to at least one system (e.g., the operator device 171). In some implementations, the model evaluation system 120 provides the explanation information via a user interface system (e.g., user interface system 126, a user interface provided by the application server 111). Additionally (or alternatively), the model evaluation system 120 provides the explanation information via an API (e.g., provided by the application server iii). In some variations, providing the generated information (S240) includes providing information identifying each feature group and the corresponding explanatory text for each feature group (e.g., information generated at S220). In some variations, providing the generated information (S240) includes providing output-specific explanation information for output generated by the model (e.g., adverse action reason codes) (e.g., information generated at S230).

In some variations, the user interface system 126 performs at least a portion of S240. In some variations, the application server 111 performs at least a portion of S240.

In some variations, the system 100 is implemented by one or more hardware devices. In some variations, the system 120 is implemented by one or more hardware devices. FIG. 3 shows a schematic representation of architecture of an exemplary hardware device 300.

In some variations, one or more of the components of the system are implemented as a hardware device (e.g., 300 shown in FIG. 3). In variants the hardware device includes a bus 301 that interfaces with the processors 303A-N, the main memory 322 (e.g., a random access memory (RAM)), a read only memory (ROM) 304, a processor-readable storage medium 305, and a network device 311. In some variations, the bus 301 interfaces with at least one of a display device 391 and a user input device 381.

In some variations, the processors 303A-303N include one or more of an ARM processor, an X86 processor, a GPU (Graphics Processing Unit), a tensor processing unit (TPU), and the like. In some variations, at least one of the processors includes at least one arithmetic logic unit (ALU) that supports a SIMD (Single Instruction Multiple Data) system that provides native support for multiply and accumulate operations.

In some variations, at least one of a central processing unit (processor), a GPU, and a multi-processor unit (MPU) is included.

In some variations, the processors and the main memory form a processing unit 399. In some variations, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip).

In some variations, the processing unit includes at least one arithmetic logic unit (ALU) that supports a SIMD (Single Instruction Multiple Data) system that provides native support for multiply and accumulate operations. In some variations the processing unit is a Central Processing Unit such as an Intel processor.

In some variations, the network device 311 provides one or more wired or wireless interfaces for exchanging data and commands. Such wired and wireless interfaces include, for example, a universal serial bus (USB) interface, Bluetooth interface, Wi-Fi interface, Ethernet interface, near field communication (NFC) interface, and the like.

Machine-executable instructions in software programs (such as an operating system, application programs, and device drivers) are loaded into the memory (of the processing unit) from the processor-readable storage medium, the ROM or any other storage location. During execution of these software programs, the respective machine-executable instructions are accessed by at least one of processors (of the processing unit) via the bus, and then executed by at least one of processors. Data used by the software programs are also stored in the memory, and such data is accessed by at least one of processors during execution of the machine-executable instructions of the software programs. In some variations, the processor-readable storage medium is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like.

In some variations, the processor-readable storage medium 305 includes machine executable instructions for at least one of an operating system 330, applications 313, device drivers 314, the feature contribution module 122, the output explanation module 124, and the user interface system 126. In some variations, the processor-readable storage medium 305 includes at least one of data sets (e.g., 181) (e.g., input data sets, evaluation input data sets, reference input data sets), and modeling system information (e.g., 182) (e.g., access information, boundary information).

In some variations, the processor-readable storage medium 305 includes machine executable instructions, that when executed by the processing unit 399, control the device 300 to perform at least a portion of the method 200.

In some variations, the system and methods are embodied and/or implemented at least in part as a machine configured to receive a computer-readable medium storing computer-readable instructions. In some variations, the instructions are executed by computer-executable components integrated with the system and one or more portions of the processor and/or the controller. The computer-readable medium can be stored on any suitable computer-readable media such as RAMs, ROMs, flash memory, EEPROMs, optical devices (CD or DVD), hard drives, floppy drives, or any suitable device. In some variations, the computer-executable component is a general or application specific processor, but any suitable dedicated hardware or hardware/firmware combination device can alternatively or additionally execute the instructions.

Although omitted for conciseness, the preferred embodiments include every combination and permutation of the various system components and the various method processes.

As a person skilled in the art will recognize from the previous detailed description and from the figures and claims, modifications and changes can be made to the preferred embodiments of the invention without departing from the scope of this invention defined in the following claims.

What is claimed is:

1. A method comprising: with a model evaluation system:
accessing model access information for a trained predictive model;
selecting a plurality of evaluation input rows for the trained predictive model;
selecting a plurality of reference input rows for the trained predictive model;
identifying each feature included in the selected evaluation input rows;
for each identified feature, determining a distribution of feature contribution values by using the accessed model access information, the selected plurality of evaluation input rows, and the selected reference input rows;
identifying each pair of features among the identified features, each pair including a first feature and a second feature;
for each identified pair, determining a similarity metric value for the pair by using the distribution of feature contribution values determined for the first feature and the distribution of feature contribution values determined for the second feature;
determining feature groups based on the determined similarity metric values; and
storing explanation information for each feature group, wherein explanation information for a feature group identifies the feature group and human-readable output explanation information associated with the feature group.

2. The method of claim 1, wherein determining feature groups based on the determined similarity metric values comprises:
constructing a graph that comprises nodes representing each identified feature and edges representing each determined similarity metric value;
performing a node clustering process to identify node clusters of the graph based on similarity metrics assigned to the graph edges, wherein each node cluster represents a feature group.

3. The method of claim 2, wherein the node clustering process is a hierarchical agglomerative clustering process.

4. The method of claim 3, wherein determining a similarity metric value comprises performing a Kolmogorov-Smirnov test.

5. The method of claim 3, wherein determining a similarity metric value comprises by computing at least one Pearson correlation coefficient.

6. The method of claim 1, wherein selecting a plurality of evaluation input rows comprises: iteratively sampling the evaluation input rows from at least one dataset until a sampling metric computed for a current sample indicates that results generated by using the current sample are likely to have an accuracy above an accuracy threshold.

7. The method of claim 1, wherein selecting a plurality of reference input rows comprises: iteratively sampling the evaluation input rows from at least one dataset until a sampling metric computed for a current sample indicates that results generated by using the current sample are likely to have an accuracy above an accuracy threshold.

8. The method of claim 1, further comprising: with the model evaluation system automatically updating the stored explanation information in response to re-training of the predictive model.

9. The method of claim 1, further comprising: with the model evaluation system:
generating output-specific explanation information for output generated by the predictive model.

10. The method of claim 9, wherein generating output-specific explanation information for a model output generated by the predictive model comprises:
for each feature included in an input row used by the predictive model to generate the model output, generating a feature contribution value for the feature;
identifying features having feature contribution values generated for the model output that exceed associated thresholds;
accessing the human-readable output explanation information for the feature group that includes the identified features; and
generating the output-specific explanation information for the model output by using the accessed the human-readable output explanation information.

11. The method of claim 10, wherein the input row represents a credit application, wherein the model output is a credit score, and the output-specific explanation information includes at least one FCRA Adverse Action Reason Code.

12. The method of claim 11,
wherein the input row used to generate the model output is received from an application server that provides an on-line lending application that is accessible by an operator device via a public network, and
wherein the application server provides the output-specific explanation information to the operator device.

13. The method of claim 11, wherein the trained predictive model includes at least one tree model.

14. The method of claim 11, wherein the trained predictive model includes at least a gradient boosted tree forest (GBM) coupled to base signals, and a smoothed approximate empirical cumulative distribution function (ECDF) coupled to output of the GMB, wherein output values of the GBM are transformed by using the ECDF and presented as a credit score.

15. The method of claim 11, wherein the trained predictive model includes submodels including at least a GMB, a neural network, and an Extremely Random Forest (ETF), wherein outputs of the submodels are ensembled together using one of a stacking function and a combining function, and wherein an ensembled output is presented as a credit score.

16. The method of claim 11, wherein the trained predictive model includes submodels including at least a neutral network (NN), a GBM, and an ETF, wherein outputs of the submodels are ensembled by a linear ensembling module, wherein an output of the linear ensembling module is processed by a differentiable function, and wherein an output of the differentiable function is presented as a credit score.

17. The method of claim 11, wherein the trained predictive model includes at least a neutral network (NN), a GBM, and a neural network ensembling module, wherein an output of the neural network ensembling module is processed by a differentiable function.
